(19) United States
(12) Patent Application Publication
(10) Pub. No.: US 2009/0172637 A1
(43) Pub. Date: Jul. 2, 2009

(54) MARKUP-BASED LANGUAGE FOR MANIFESTS

(75) Inventor: Sujal S. Parikh, Redmond, WA (US)

Correspondence Address: TUROCY & WATSON, LLP, 127 Public Square, 57th Floor, Key Tower, CLEVELAND, OH, 44114, US

(73) Assignee: Microsoft Corporation, Redmond, WA (US)

(21) Appl. No.: 11/965,865

(22) Filed: Dec. 28, 2007

(51) Int. Cl. G06F 9/44

(52) U.S. Cl. 717/114

(57) ABSTRACT

Applications are deployed with manifests authored in a markup-based language to leverage the benefits afforded thereby. Application manifests are simple and easily expressible without requiring a complex implementation. Markup elements or tags can be mapped directly to objects or an object hierarchy visible to programmers to enable fine grain control. Programmers can subsequently interact with these objects in a predictable and consistent manner.

### BACKGROUND

Computer programs are groups of instructions that describe actions to be performed by a computer or other processor-based device. When a computer program is loaded and executed on computer hardware, the computer will behave in a predetermined manner by following the instructions of the computer program. Accordingly, the computer becomes a specialized machine that performs tasks prescribed by the instructions.

A programmer using one or more programming languages creates the instructions comprising a computer program. Typically, source code is specified or edited by a programmer manually and/or with help of an integrated development environment (IDE). Subsequently, the source code can be compiled or otherwise transformed by another program into computer instructions executable by a computer or like device.

Programs can be deployed for use on one or more client devices. For example, a program can be published initially on a website, network shared source or on a media such as a compact disc. A program can be installed on an end-user device and accessed even when offline. Alternatively, a program can be installed remotely or a server, for instance, and run online without installing anything permanent on the device. A hybrid is also possible, in which code installation and execution is split between a local device and a remote server.

Installation and/or deployment are governed by at least one manifest, which can form part of an application. An application manifest is authored by the application developer and describes or defines an application in terms of its component parts and relationships, among other things. In other words, a manifest provides information regarding application components and needs of an application in an environment. For example, a manifest can include application name, execution entry point, and libraries employed. Manifests can also reference other manifests. This information is utilized by an application loader to load a program for execution.

Conventionally, manifests are specified in XML (eXtensible Markup Language). Various tags or elements are utilized to label manifest data in distinct manners. More specifically, a number of different or customized manifest data schemas are employed to specify the data.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to application deployment utilizing manifests. More specifically, an application manifest is specified in a markup-based language including but not limited to conventional presentation-targeted markup languages (e.g., XAML, XUL . . . ). In accordance with aspects of the disclosure, a standard set of language markup elements or tags are utilized to declare a manifest. Subsequently, these elements can be mapped directly to the same or similar objects forming an object hierarchy that can be utilized to deploy an application. Furthermore, an interface can be employed to enable fine grain programmatic control of manifest objects and interaction with such objects in a predictable and consistent manner.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that facilitates application deployment in accordance with an aspect of the disclosed subject matter.

FIG. 2 is a block diagram of a representative manifest component in accordance with a disclosed aspect.

FIG. 3 is a block diagram of a manifest processing system according to an aspect of the disclosed subject matter.

FIG. 4 is a block diagram of a representative interface component for interacting with a manifest representation.

FIG. 5 is a block diagram of a system that facilitates application deployment in accordance with an aspect of the claimed subject matter.

FIG. 6 is a flow chart diagram of a manifest creation method in accordance with an aspect of the claimed subject matter.

FIG. 7 is a flow chart diagram of a method of manifest processing according to an aspect of the disclosure.

FIG. 8 is a flow chart diagram of a method of interacting with a manifest representation in accordance with an aspect of the disclosure.

FIG. 9 is a flow chart diagram of an application deployment method in accordance with an aspect of the disclosure.

FIG. 10 is a schematic block diagram illustrating a suitable operating environment for aspects of the subject disclosure.

FIG. 11 is a schematic block diagram of a sample-computing environment.

### DETAILED DESCRIPTION

Systems and methods are described hereinafter with respect to authoring and employment of application manifests and the like. Markup-based languages can be utilized to implement application manifests, and the richness of such languages leveraged to facilitate interaction. For instance, markup language elements can be mapped to directly to objects accessible by programmers. Among other things, this feature allows consistent and predictable interaction with, as well as fine-grained control over, a manifest or more specifically objects comprising the manifest.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

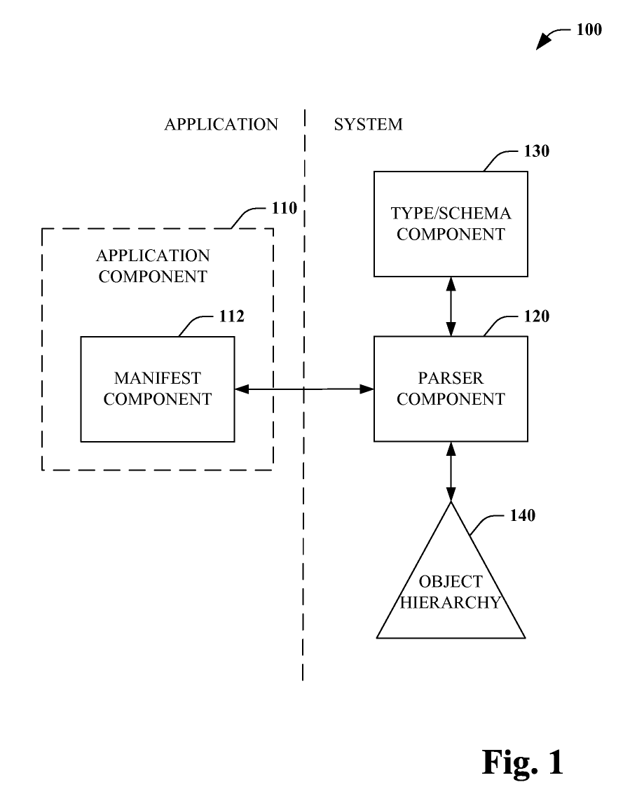

Referring initially to FIG. 1, a system that facilitates application deployment 100 is illustrated in accordance with an aspect of the claimed subject matter. The system 100 includes an application component 110 and an associated manifest component 112. The application component 110 includes programmatic logic and functionality, among other things, for execution on a system such a computer or other processor-based device. Furthermore, the application component 110 can comprise a plurality of pieces or parts including various assemblies or object code (e.g., executable file, library . . . ) and/or functional components/modules, among other things. At least a subset of these parts will need to be loaded and an entry point identified for initiating execution. The manifest component 112 provides such information regarding the application and application requirements in a particular environment.

In some cases, a markup language like XML (eXtensible Markup Language) can be employed for manifest specification. Markup languages combine text with additional information about the text for instance in the form of tags (e.g., “<book>The Great Gatsby</book>”). A markup language can be extended to allow users to define their own tags in a schema, for instance. In this manner, sharing of structured data is facilitated across systems. While beneficial in some cases, the flexibility afforded by a markup language can be a disadvantage for manifests. In particular, many different custom schemas can be developed for specifying manifests which results in incompatibilities and the need for duplicative supporting infrastructure. Moreover, even if a schema could be standardized for manifests, resultant objects or other representations are still inconsistent making it difficult for programmers to interact with the manifest representation.

In accordance with an aspect of the claimed subject matter, the manifest component 112 can be implemented utilizing a markup-based language. Markup languages like XML are solely designed to store data. Markup-based languages are an extension of markup languages that provide more than just a way to store data. In addition, markup-based languages can provide application logic inline or behind the scenes, for instance. Hence, a markup-based language can refer to a declarative logic language. Moreover, such languages can be utilized to initialized objects and relationships between objects.

A few markup-based languages (also referred to as user interface markup languages) exist including XAML (eXtensible Application Markup Language) and XUL (eXtensible User interface Language), among others. These and other conventional languages were invented initially for presentation or display purposes. In particular, these languages are utilized to create or define user interface elements and application logic or flow control in a declarative manner.

According to an aspect of the claimed subject matter, such languages can be extended and applied to application manifests rather than or in addition to their convention presentation functionality. Moreover, the functionality and infrastructure can be leveraged for use with respect to application manifests. In particular, markup elements or tags can be mapped directly to objects. Among other things, this can enable predictable and consistent interaction with manifest related objects. Additionally, there is no need to learn a completely new language. Once a user interface markup language is understood, programmers can easily grasp the manifest extension. Furthermore, convention presentation infrastructure such as designers, validators, visualizers, amongst others, can be reused if desired essentially providing support for manifests free of cost. Still further yet, flexibility is provided to further develop aspects incrementally or in parallel.

As shown in system 100, the manifest component 112 can be received or retrieved on a system side by a parser component 120 communicatively coupled to the type/schema component 130. The parser component 120 parses the manifest component 112 and maps markup elements or tags directly to language objects utilizing information regarding language types, classes, schemas or the like from type/schema component 130. For instance, element names and attributes can correspond to an object class and object properties, respectively. It is to be appreciated that the type/schema component 130 can contain additional types or schemas related to manifests such as a deployment class. These objects can then be loaded into an in-memory structure such as object hierarchy 140. Such direct and consistent mapping of a markup representation to an object model enables developers to obtain fine grain control of manifest objects and aids interaction in a predictable and consistent manner, similar to the mapping they are already familiar with in the presentation space.

It is to be noted that parser component 120 can be a specialized component for parsing manifests. Alternatively, a conventional user interface markup language parser can be retargeted or altered to support manifests. As such, current technology can be leveraged for parsing and object creation related to a markup-based language representation of a manifest.

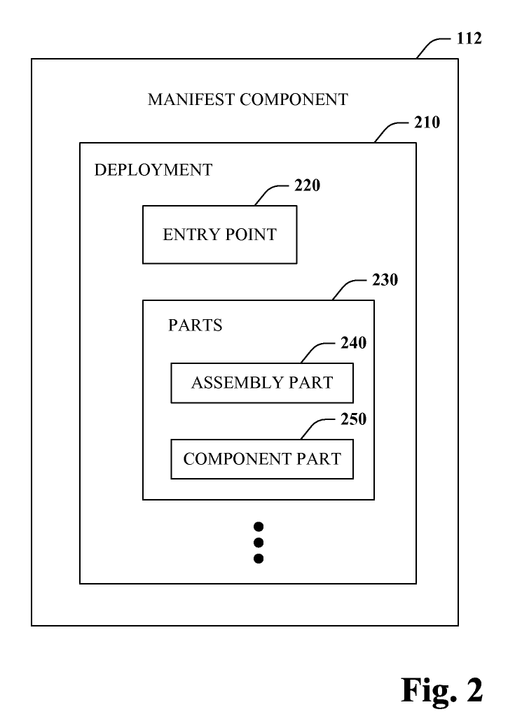

Turning attention to FIG. 2, a representative manifest component 112 is depicted in accordance with an aspect of the claimed subject matter. The manifest component 112 can include a plurality of subcomponents defining markup tags or elements such as those associated with a declarative language such as XML. As shown the representative manifest component 112 includes a deployment component or element 210, which includes a number of property elements 220 and 230. Property element 220 identifies an entry point for initiating application execution. Property element 230 identifies application parts required for application execution. The parts property element 230 includes additional elements, namely assembly part 240 and component part 250. The assembly part 240 identifies specific assemblies corresponding to reusable, versionable, application building blocks including executable files, libraries, and the like. The component part 250 specifies additional components or applications that may be required and can reference other manifests. This provides an intuitive approach to specifying or linking multiple manifests similar to the manner in which “<IFRAME>” and “<FRAME>” work in HTML (HyperText Markup Language). This improves developer experience by utilizing familiar and efficient coding techniques, inter alia.

What follows is an exemplary manifest specified in XAML. It is to be appreciated that the exemplary code is not meant to limit the appended claims in any manner but rather to further aid clarity and understanding with respect to aspects of the claimed subject matter.

```
<Deployment xmlns=“http://schemas.microsoft.com/client/2007”
      xmlns:x=“http://schemas.microsoft.com/winfx/2006/xaml”
      xmlns:custom=“clr-
      namespace:MyNameSpace;assembly=MyApplication.dll”
      RequiredRuntimeVersion=“2.0.0.0” NeutralCulture=“en-US”>
  <Deployment.EntryPoint>
    <custom:MyApplication/>
  </Deployment.EntryPoint>
  <Deployment.Parts>
    <AssemblyPart x:Name=“MyDll1” Source=“MyDll1.dll”
Version=“1.0.0.0” Culture=“Neutral”
            PublicKeyToken=“1nekot12yek123cilbup” />
    <AssemblyPart x:Name=“MyDll2” Source=“MyDll2.dll”
Version=“2.0.0.0” Culture=“Neutral”
            PublicKeyToken=“4nekot45yek456cilbup” />
    <ComponentPart x:Name=“MyCompPkg” Source=
    “Components/Foo.zip”/>
  </Deployment.Parts>
  <Deployment.RequiredExtensions>
      <Extension x:Name=“DLR” Source=“dlr.sl” />
  </Deployment.RequiredExtensions>
  <Deployment.SupportedCultures>
    <SupportedCulture Name=“ja-JP” />
    <SupportedCulture Name=“de-DE” />
  </Deployment.SupportedCultures>
</Deployment>
```

Here, the “Deployment” tag is provided which means there will be a corresponding deployment object instance or an object instance of type deployment. This root element includes three namespace attributes providing element definitions. The first namespace “xmlns . . . ” is the default and it defines “Deployment,” among other things. The namespaces “xmlns: x= . . . ” and “xmlns: custom . . . ” provide an additional and custom namespace, respectively. The additional namespace identifies extra tags needed to be able to represent objects in markup or the XAML specific elements. The custom namespace are types created by developers. The first element property is “EntryPoint” that indicates that an entry point into this application is described by the custom type “MyApplication.”

The second element property is “Parts” which defines a collection of parts required for application execution. The first part is an assembly part whose name is defined as “x:name= . . . ” This provides a standard way of declaring an id or name. By contrast, there is no standard in XML so developers use “ids,” “IDS,” “Ids,” among others, to declare an id or name. As a result of such language-imposed standardization, a consistent interface can be employed to find a name. If a find name “MyDll1” is performed, an object can be returned of type assembly part. Also included in the assembly part is a source. Similar to presentation XAML where an image may be the source, a source can be designated for a named assembly part.

Another portion of “Parts” element is “ComponentPart,” which points to a component used by an application. For example, this could correspond to a calendaring component, a charting component, or another manifest component. Here, the component part refers to “MyCompPkg” and points to source “Components/Foo.zip.” It is to be noted that the component part itself can be built of multiple files and components. Thus, there can be nesting of components in this manner.

A plurality of other element properties can also be included under the root deployment tag. As shown, the exemplary manifest includes a “RequiredExtension” property and a “SupportedCultures” property for designation of extensions and supported cultures for an application, respectively.

On the client side when this manifest is analyzed it tells an application loader, for instance, to start the application by executing the type “MyApplication.” However, prior to execution three parts need to be loaded or downloaded, namely “MyDll1,” “MyDll2,” and “MyCompPkg.” Still further yet, these parts can require their own parts. Hence, a progress bar can be displayed while the parts are loaded. Subsequently, the application will be executed or spawned.

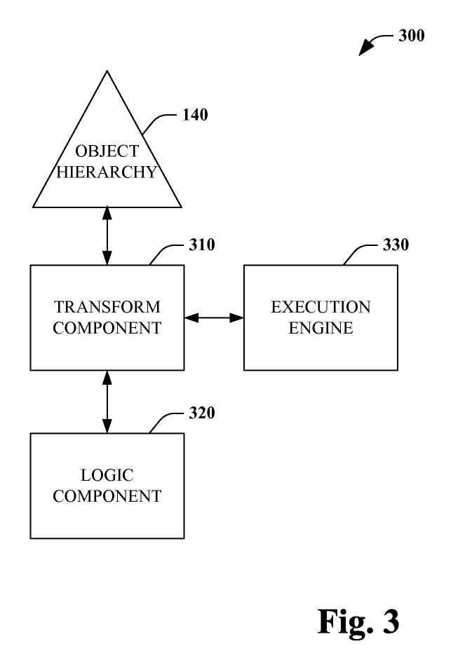

Referring to FIG. 3, a manifest processing system 300 is illustrated according to an aspect of the claimed subject matter. As previously described a markup-based language manifest can be parsed and loaded in memory in the form of a hierarchy of one or more objects and associated attributes, among other things. Transform component 310 can transform or otherwise interpret the object hierarchy 140. Accordingly, the transform component 310 can be embodied as a compiler, interpreter, or the like. Additional logic or functionality associated with the objects provided by logic component 320 can be utilized or injected by transform component 310. An execution engine 330 processes a transformed version of the object hierarchy 140 to affect associated functionality. In particular, the execution engine 330 can load required application parts and initiate application execution.

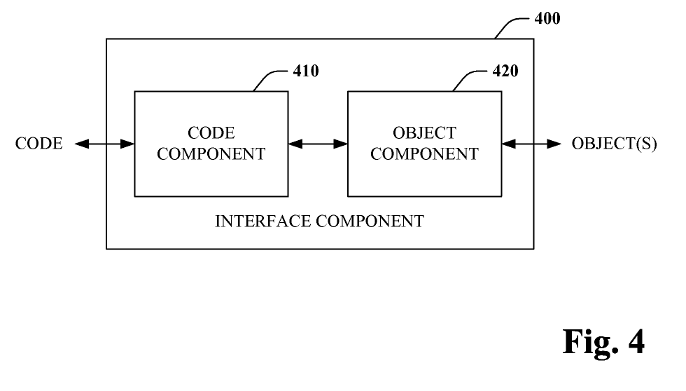

FIG. 4 depicts a representative interface component 400 for interacting with a manifest representation. According to one embodiment, the interface component 400 can correspond to an application programming interface (API); however, it is not limited thereto. The interface includes a code component 410 and an object component 420. The code component 410 receives, retrieves or otherwise obtains or acquires programmatic code that seeks to alter an object model representation of a manifest. The code component 410 interacts with the object component 420, which affects the desired alterations including adding, removing, or otherwise modifying one or more objects or an object hierarchy. In one implementation, the object component 420 can make particular methods and/or calls available to the code component to bring about changes. Similarly, the code component 410 can make calls available to the object component 420. In accordance with an aspect of this disclosure, markup-based language elements are mapped directly to objects. As a result, calls made available by the object component 420 can be consistent with the elements thereby facilitating interaction. For example, a deployment element can be mapped directly to a deployment object and properties thereof can be accessed by utilizing the dot operator such as “Deployment.EntryPoint.”

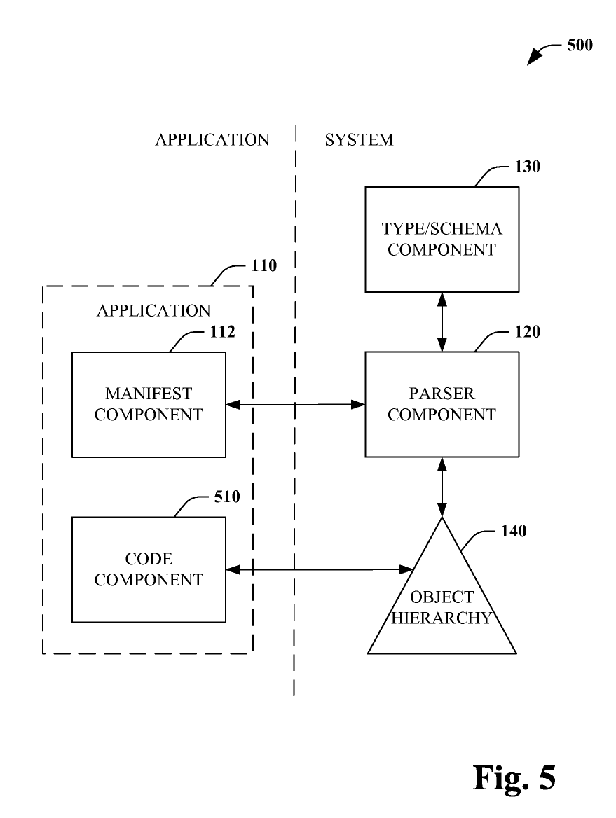

Turning attention to FIG. 5, a system 500 is illustrated that facilitates application deployment. Similar to the system 100 of FIG. 1, the system 500 includes a manifest component 112 associated with an application 110 that is parsed by parser component 120 with the aid of type/schema component 130 to produce the object hierarchy 140. The application 110 can also include a code component 510 that can interact with the object hierarchy 140 via the interface component 400 of FIG. 4, for example. The code component 140 can add, delete, or otherwise alter the object hierarchy 140 or an object therein. Changes to the object hierarchy can trigger corresponding action.

By way of example and not limitation, a component may not be loaded initially prior to application execution due to infrequent use. However, during application execution a user may initiate action that requires the component. In this instance, upon detection the code component 510 can modify the object hierarchy to prompt loading of the component. Moreover, the code necessary to affect this change is simple and consistent. More specifically, a deployment part can be created and hooked into the object hierarchy tree. This is similar to what developers are familiar with doing in web development, for instance, where a button is hooked into a webpage and it automatically appears there. As per manifests, conventionally code had to call some initially unknown method utilizing an obscure API. Consistency is not enforced as is done where a markup-based language is employed, for example.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, types or schemas can be arbitrarily rich and include such intelligent mechanisms to affect predictive-downloading of application parts. More specifically, a part object can be implemented in such a way as to predict whether it is needed or not and automatically initiate a download such that the functionality afforded by the part is available when needed or requested.

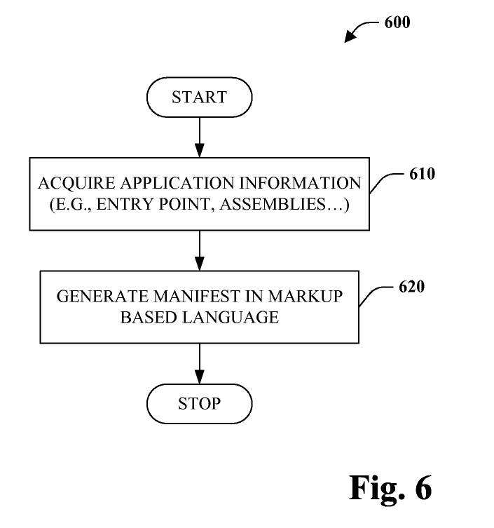

In view of the exemplary systems described supra, methodologies that may be implemented in accordance with the disclosed subject matter will be better appreciated with reference to the flow charts of FIGS. 6-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 6, a manifest creation method 600 is depicted in accordance with an aspect of the claimed subject matter. At reference numeral 610, application deployment information is acquired. This can include an entry point as well as required assemblies, among other things. Such information can be acquired from a developer via a user interface, for example. Utilizing the information acquired as a whole or incrementally, a manifest is generated in a markup-based language such as a conventional user interface markup language (e.g., XAML, XUL . . . ). Employing such languages conventionally utilized for presentation provides many benefits. Overall, a markup-based language authored manifest is toolable, powerful and extensible yet simple and easily expressible. Furthermore, existing infrastructure can be leveraged reducing needed development efforts to support such functionality.

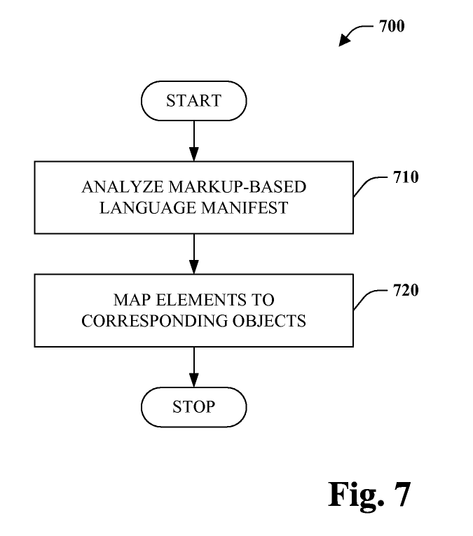

FIG. 7 is a flow chart diagram of a method of manifest processing 700 according to an aspect of the claimed subject matter. At reference numeral 710, a markup-based language manifest is analyzed or scanned. In other words, a lexical analysis is performed on the manifest to identify a sequence of tokens. At numeral 710, markup elements or tokens are mapped to corresponding objects or instances of a class. For example, a markup element can be mapped to an object or class of the same or similar name and element attributes mapped to an identified object property. The result is a tree or hierarchy of objects representing the manifest that can be processed and/or programmed against. Here, the object model matches or substantially corresponds to the markup representation thereby making it easy for developers to utilize.

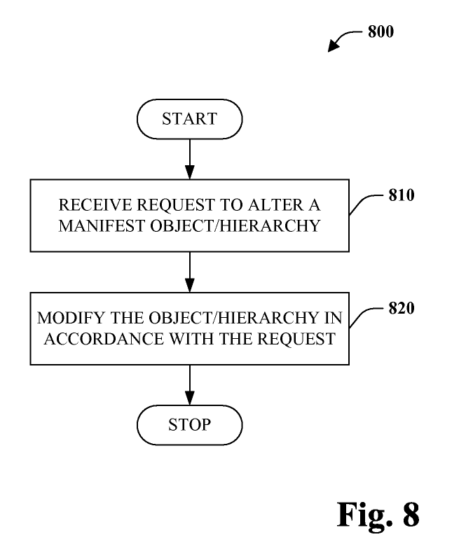

Referring to FIG. 8, a method of interacting with a manifest representation 800 is shown in accordance with an aspect of the claimed subject matter. At reference numeral 810, a request is received identifying a desired modification (e.g., add, remove, change, alter . . . ) to an object or object hierarchy generated from a markup-based language specified manifest. In one instance, the request can originate from application code although the claims are not limited thereto. The request can also take the form of a command or call publicized for use in modifying an object and/or hierarchy. At reference 810, the request is processed and the object and/or hierarchy are modified accordingly. For example, an application and/or associated logic and determine, infer or predict that a component is needed that was not loaded initially with the application at deployment time. In this case, a request can be made to link the required component into the object hierarchy and ultimately initiate loading of that component for use by the application. In some instances, one or more other components can be unloaded to make room for the new component. Utilizing method 810, fine-grained control can be enabled over manifest related objects. Moreover, objects can be interacted with in a predictable and consistent manner.

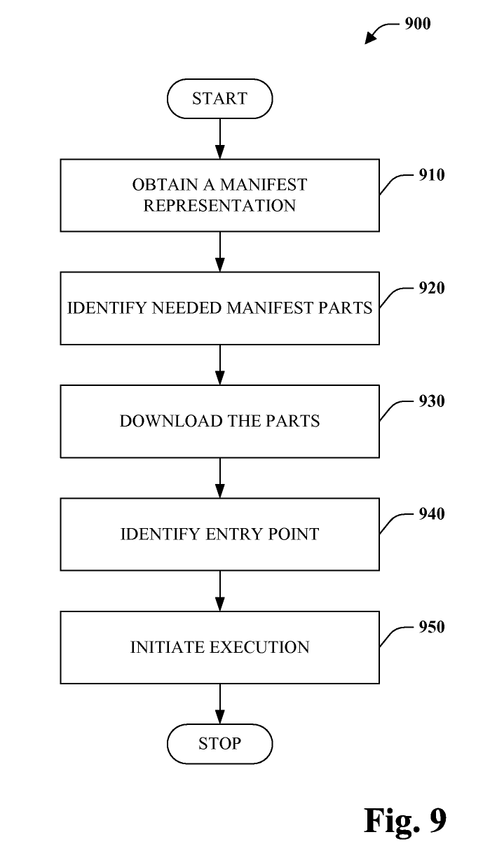

FIG. 9 is a flow chart diagram depicting an application deployment method 900 in accordance with an aspect of the claimed subject matter. At reference numeral 910, a manifest representation is obtained or otherwise identified. For example, the manifest can be captured as a tree or object hierarchy generated from a markup-based language manifest. Needed parts are identified from the manifest at reference 920. Such parts can correspond to assemblies including executable files and libraries (e.g., dynamically linked libraries (dlls)), componentized or modularized functionality (e.g., calendaring component, charting component . . . ) as well as other applications and/or manifests, among other things. It is to be further noted that identification of needed parts can be recursive since parts can be nested. At numeral 930, the identified need parts are loaded and/or downloaded. An entry point for the application is identified from the manifest at reference 940. Execution of the application is triggered at the identified entry point at reference numeral 950.

The term “markup-based language” is used herein to specify a programming language that utilizes a markup language representation and maps elements or tags of the markup to the same or similar objects in a tree or object hierarchy, among other things. In one embodiment, the markup language can be XML, but is not limited thereto. Furthermore, a few conventional languages meet this definition including XAML and XUL. However, these languages are currently targeted toward graphical interfaces and are thus often referred to as user interface markup languages or the like. The term “markup-based language” is meant to encompass these and like languages. Nevertheless, aspects of the claimed subject matter concern retargeting or extending such languages for manifests and as such, the presentation bias in the descriptive term is not used since it is unnecessary and confusing in this context.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

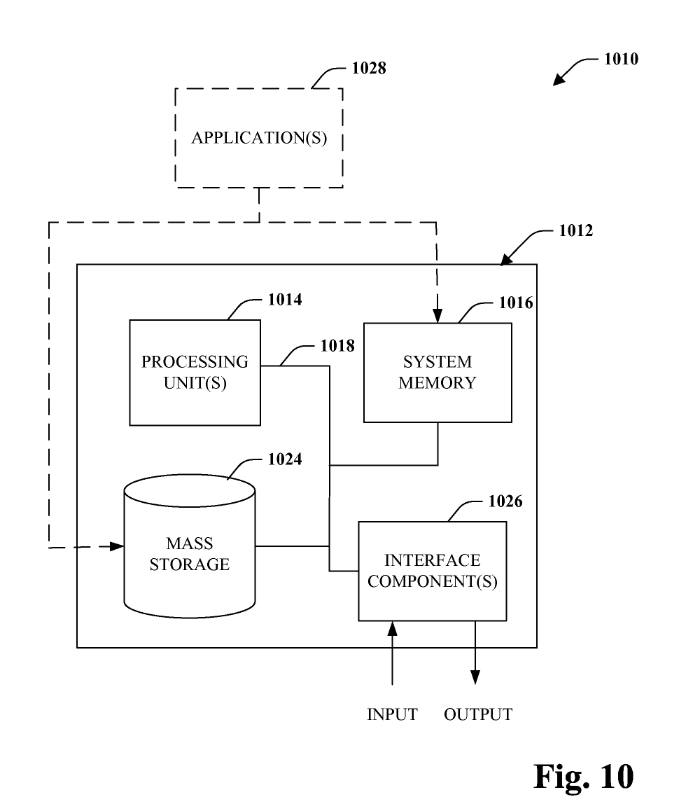

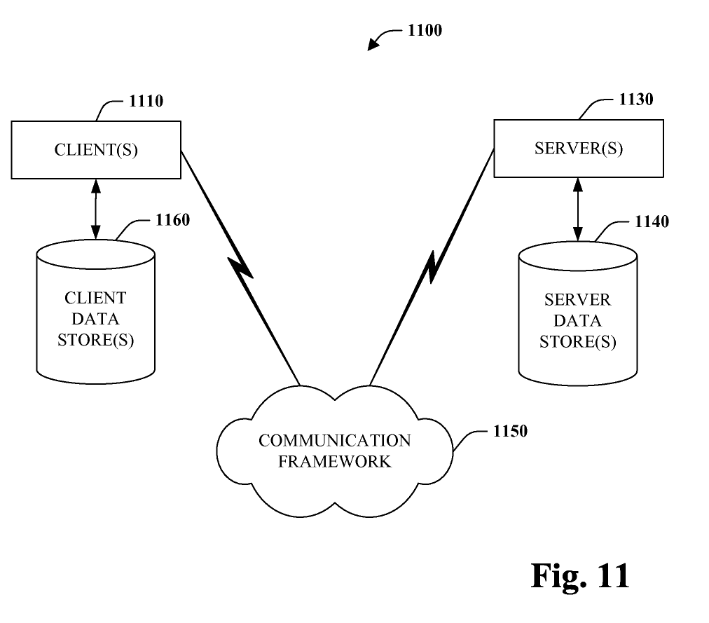

In order to provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 10, an exemplary environment 1010 for implementing various aspects disclosed herein includes a computer 1012 (e.g., desktop, laptop, server, hand held, programmable consumer or industrial electronics . . . ). The computer 1012 includes a processing unit 1014, a system memory 1016, and a system bus 1018. The system bus 1018 couples system components including, but not limited to, the system memory 1016 to the processing unit 1014. The processing unit 1014 can be any of various available microprocessors. It is to be appreciated that dual microprocessors, multi-core and other multiprocessor architectures can be employed as the processing unit 1014.

The system memory 1016 includes volatile and nonvolatile memory. The basic input/output system (BIOS), containing the basic routines to transfer information between elements within the computer 1012, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1012 also includes removable/non-removable, volatile/non-volatile computer storage media. FIG. 10 illustrates, for example, mass storage 1024. Mass storage 1024 includes, but is not limited to, devices like a magnetic or optical disk drive, floppy disk drive, flash memory, or memory stick. In addition, mass storage 1024 can include storage media separately or in combination with other storage media.

FIG. 10 provides software application(s) 1028 that act as an intermediary between users and/or other computers and the basic computer resources described in suitable operating environment 1010. Such software application(s) 1028 include one or both of system and application software. System software can include an operating system, which can be stored on mass storage 1024, that acts to control and allocate resources of the computer system 1012. Application software takes advantage of the management of resources by system software through program modules and data stored on either or both of system memory 1016 and mass storage 1024.

The computer 1012 also includes one or more interface components 1026 that are communicatively coupled to the bus 1018 and facilitate interaction with the computer 1012. By way of example, the interface component 1026 can be a port (e.g., serial, parallel, PCMCIA, USB, FireWire . . . ) or an interface card (e.g., sound, video, network . . . ) or the like. The interface component 1026 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1012 to output device(s) via interface component 1026. Output devices can include displays (e.g., CRT, LCD, plasma . . . ), speakers, printers and other computers, among other things.

FIG. 11 is a schematic block diagram of a sample-computing environment 1100 with which the subject innovation can interact. The system 1100 includes one or more client(s) 1110. The client(s) 1110 can be hardware and/or software (e.g., threads, processes, computing devices). The system 1100 also includes one or more server(s) 1130. Thus, system 1100 can correspond to a two-tier client server model or a multi-tier model (e.g., client, middle tier server, data server), amongst other models. The server(s) 1130 can also be hardware and/or software (e.g., threads, processes, computing devices). The servers 1130 can house threads to perform transformations by employing the aspects of the subject innovation, for example. One possible communication between a client 1110 and a server 1130 may be in the form of a data packet transmitted between two or more computer processes.

The system 1100 includes a communication framework 1150 that can be employed to facilitate communications between the client(s) 1110 and the server(s) 1130. The client(s) 1110 are operatively connected to one or more client data store(s) 1160 that can be employed to store information local to the client(s) 1110. Similarly, the server(s) 1130 are operatively connected to one or more server data store(s) 1140 that can be employed to store information local to the servers 1130.

Client/server interactions can be utilized with respect with respect to various aspects of the claimed subject matter. In fact, while aspects of the claimed subject matter can concern conventional deployment directly on a client 1110, they can also pertain to service deployment in a web browser, for instance. Accordingly, a manifest can be provided to a browser executing on a client 1110 from a server 1130 across the communication framework 1150. Based thereon, parts and/or components required for execution can be downloaded from one or more servers 1130 and execution initiated as specified. Additional parts and/or components can subsequently be downloaded to a client 1110 from one or more servers 1130 as needed. In one particular implementation, infrastructure utilized by a user interface markup language like XAML for presentation including parsers, loaders and the like can be reused or leveraged for employment with manifests thereby reducing code size for network based applications, among other things.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A system to facilitate application deployment, comprising:
a manifest component specified in an markup-based language; and
a parser component that builds an in-memory representation of the manifest component.

2. The system of claim 1, the parser component maps manifest elements directly to programmatic objects.

3. The system of claim 2, the parser component maps manifest element names and attributes to object class names and properties.

4. The system of claim 2, the in-memory representation is a hierarchy of objects.

5. They system of claim 4, another manifest component is represented as a sub-tree of nodes in a tree that represents the manifest component.

6. The system of claim 2, further comprising a component that identifies object types or classes for use by the parser component.

7. The system of claim 2, further comprising an interface component to enable object manipulation.

8. The system of claim 7, further comprising a code component that causes a change, addition, and/or deletion of an object during application execution.

9. The system of claim 2, further comprising an execution engine that executes the manifest component.

10. The system of claim 9, further comprising a component that compiles or interprets the programmatic objects and/or associated logic prior to or concurrent with execution.

11. The system of claim 1, the manifest component is specified in an XML-based language.

12. An application deployment method, comprising:
acquiring an application manifest specified in a markup-based programming language; and
deploying an application in accordance with the manifest.

13. The method of claim 12, further comprising mapping manifest elements directly to a corresponding object in an object hierarchy.

14. The method of claim 13, further comprising altering the object and/or object hierarchy in response to a request.

15. The method of claim 13, further comprising processing the application manifest.

16. The method of claim 12, further comprising downloading identified parts and initiating application execution as specified.

17. A computer-readable medium having stored thereon an application manifest, comprising:
at least one manifest element specified in a markup-based programming language; and
application specific information associated with the element.

18. The application manifest of claim 17, the at least one element is a deployment element with a number of properties.

19. The application manifest of claim 18, the properties represent an entry point and a collection of parts including an assembly part and a component part.

20. The application manifest of claim 18, further comprising identification of another application manifest.
